(19) United States
(12) Patent Application Publication
(10) Pub. No.: US 2023/0264568 A1
(43) Pub. Date: Aug. 24, 2023

(54) MOTOR VEHICLES INCLUDING HYDRAULIC DRIVE UNITS

(71) Applicant: Edward Wayne Mattson, Brainerd, MN (US)

(72) Inventor: Edward Wayne Mattson, Brainerd, MN (US)

(21) Appl. No.: 18/108,290

(22) Filed: Feb. 10, 2023

Related U.S. Application Data
(60) Provisional application No. 63/313,629, filed on Feb. 24, 2022.

(51) Int. Cl. B60K 17/10; F16H 47/06

(52) U.S. Cl. CPC B60K 17/10; F16H 47/065

(57) ABSTRACT

A drivetrain for a motor vehicle includes a prime mover including a rotatable power shaft, wherein the prime mover is configured to translate energy stored in a power source into rotational torque that is applied to the power shaft, a hydraulic drive unit including a hydraulic pump mechanically connected to the power shaft, a hydraulic motor fluidically connected to the hydraulic pump, and an output shaft mechanically connected to the hydraulic motor, and a transmission mechanically connected to the output shaft and configured to provide one or more gear reductions across the transmission.

### CROSS-REFERENCE TO RELATED APPLICATIONS

This application claims benefit of U.S. provisional patent application Ser. No. 63/313,629 filed Feb. 24, 2022, and entitled “Motor Vehicles Including Hydraulic Drive Units,” which is hereby incorporated herein by reference in its entirety for all purposes.

### STATEMENT REGARDING FEDERALLY SPONSORED RESEARCH OR DEVELOPMENT

Not applicable.

### BACKGROUND

Motor vehicles are utilized for a variety of purposes including, for example, transporting people and/or cargo across a surface or terrain. Motor vehicles, including passenger and commercial vehicles, generally include a drivetrain for transporting the motor vehicle across the terrain such as a road or off-road terrain. The drivetrain of a motor vehicle typically includes a prime mover, a transmission, and one or more drive wheels. The prime mover may convert energy such as, for example, electrical and/or chemical energy, into rotational torque that is applied to the transmission of the motor vehicle. The transmission may comprise a gearbox including one or more mechanical gears providing one or more fixed gear ratios, and/or a continuously variable transmission (CVT). The transmission, in-turn, provides a desired output rotational speed that is applied to the one or more drive wheels of the motor vehicle. The drive wheels may be coupled to elastomeric tires, tracks, and/or other mechanisms for transferring the rotational torque applied to the one or more drive wheels to the terrain to thereby propel the motor vehicle across the terrain.

### SUMMARY

An embodiment of a drivetrain for a motor vehicle comprises a prime mover comprising a rotatable power shaft, wherein the prime mover is configured to translate energy stored in a power source into rotational torque that is applied to the power shaft; a hydraulic drive unit comprising a hydraulic pump mechanically connected to the power shaft, a hydraulic motor fluidically connected to the hydraulic pump, and an output shaft mechanically connected to the hydraulic motor; and a transmission mechanically connected to the output shaft and configured to provide one or more gear reductions across the transmission. In some embodiments, the hydraulic pump comprises a pump housing and a motive element positioned in the pump housing and mechanically connected to the power shaft. In some embodiments, the motive element of the hydraulic pump comprises at least one of an impeller rotatably positioned in the pump housing and a piston reciprocally positioned in the pump housing. In certain embodiments, the hydraulic motor comprises a motor housing and a drive element positioned in the motor housing and mechanically connected to the output shaft. In certain embodiments, the drive element of the hydraulic pump comprises at least one of an impeller rotatably positioned in the motor housing and a piston reciprocally positioned in the motor housing. In some embodiments, the prime mover comprises an electric motor configured to output rotational torque to the power shaft in response to being provided with electrical energy from the power source. In some embodiments, the transmission comprises a continuously variable transmission (CVT).

An embodiment of a motor vehicle comprises a chassis; a power source supported on the chassis; a prime mover supported on the chassis and comprising a rotatable power shaft, wherein the prime mover is configured to translate energy stored in the power source into rotational torque that is applied to the power shaft; a hydraulic drive unit supported on the chassis and mechanically connected to the power shaft, wherein the hydraulic drive unit comprises a hydraulic circuit and an output shaft connected to the power shaft through the hydraulic circuit; a transmission mechanically connected to the output shaft of the hydraulic drive unit and configured to provide one or more gear reductions across the transmission; and one or more traction elements mechanically connected to the transmission and configured to react a force against a surface terrain in response to the operation of the prime mover. In some embodiments, the motor vehicle comprises a control system supported on the chassis and in signal communication with the prime mover, hydraulic drive unit, and transmission. In some embodiments, the one or more traction elements comprise one or more wheels rotatably coupled to the transmission. In certain embodiments, the motor vehicle comprises a differential mechanically connected between the transmission and the one or more wheels. In certain embodiments, the hydraulic drive unit comprises a hydraulic pump mechanically connected to the power shaft, and a hydraulic motor fluidically connected to the hydraulic pump and mechanically connected to the output shaft. In certain embodiments, the hydraulic pump comprises a pump housing and a motive element positioned in the pump housing and mechanically connected to the power shaft. In some embodiments, the motive element of the hydraulic pump comprises at least one of an impeller rotatably positioned in the pump housing and a piston reciprocally positioned in the pump housing. In some embodiments, the hydraulic motor comprises a motor housing and a drive element positioned in the motor housing and mechanically connected to the output shaft. In certain embodiments, the drive element of the hydraulic pump comprises at least one of an impeller rotatably positioned in the motor housing and a piston reciprocally positioned in the motor housing. In certain embodiments, the prime mover comprises an electric motor configured to output rotational torque to the power shaft in response to being provided with electrical energy from the power source. In certain embodiments, the transmission comprises a continuously variable transmission (CVT).

### BRIEF DESCRIPTION OF THE DRAWINGS

For a detailed description of exemplary embodiments, reference will now be made to the accompanying drawings in which:

FIG. 1 is a schematic view of an embodiment of a motor vehicle; and

FIG. 2 is a schematic view of an embodiment of a hydraulic drive unit of the motor vehicle of FIG. 1.

### DETAILED DESCRIPTION

In the drawings and description that follow, like parts are typically marked throughout the specification and drawings with the same reference numerals. The drawing figures are not necessarily to scale. Certain features of the disclosed embodiments may be shown exaggerated in scale or in somewhat schematic form and some details of conventional elements may not be shown in the interest of clarity and conciseness. The present disclosure is susceptible to embodiments of different forms. Specific embodiments are described in detail and are shown in the drawings, with the understanding that the present disclosure is to be considered an exemplification of the principles of the disclosure, and is not intended to limit the disclosure to that illustrated and described herein. It is to be fully recognized that the different teachings of the embodiments discussed below may be employed separately or in any suitable combination to produce desired results.

Unless otherwise specified, in the following discussion and in the claims, the terms “including” and “comprising” are used in an open-ended fashion, and thus should be interpreted to mean “including, but not limited to . . . ” Any use of any form of the terms “connect,” “engage,” “couple,” “attach,” or any other term describing an interaction between elements is not meant to limit the interaction to direct interaction between the elements and may also include indirect interaction between the elements described. The various characteristics mentioned above, as well as other features and characteristics described in more detail below, will be readily apparent to those skilled in the art upon reading the following detailed description of the embodiments, and by referring to the accompanying drawings.

As described above, motor vehicles may be utilized for transporting people and/or cargo across a surface terrain and typically include drivetrain having a prime mover, a transmission, and one or more wheels which apply force transferred from the prime mover to the ground in the form of traction. Typically, in drivetrains of conventional motor vehicles the prime mover is mechanically coupled to the transmission, and the transmission is mechanically coupled to the one or more wheels of the motor vehicle. For example, the prime mover may be mechanically connected to the transmission through a clutch while the transmission may be connected to the one or more wheels by one or more axles and/or other mechanical devices. While in some applications a fluid coupling may be provided between the prime mover and transmission in the form of a torque converter, the torque converter only serves to couple the prime mover with the transmission when the motor vehicle is being actively driven (e.g., when turbine speed has substantially reached impeller speed of the torque converter) and indeed a mechanical connection in the form of a lock-up clutch is typically provided in the torque converter to increase range and fuel efficiency. In other applications, a hydraulic unit may be employed in lieu of a gearbox or CVT to provide a desired gear reduction across the hydraulic unit to the one or more wheels of the motor vehicle.

Unlike the conventional motor vehicles outlined above, embodiments of motor vehicles are described herein which include a hydraulic drive unit configured to increase an operational efficiency of the drivetrain and thereby maximize an operational range of the motor vehicle. To state in other words, embodiments of hydraulic drive units described herein are configured to maximize the distance a given motor vehicle equipped with the hydraulic drive unit may travel using a given amount of fuel (e.g., for a motor vehicle powered by an internal combustion engine (ICE)) or electrical energy (e.g., for a motor vehicle powered by an electric motor). Thus, embodiments of motor vehicles herein may include a hydraulic drive unit in addition to a separate transmission that is mechanically coupled to the hydraulic drive unit and configured to provide a desired gear reduction across the transmission. Embodiments of hydraulic drive units described herein may increase or maximize the range of a motor vehicle by reducing the resistance of motion compared to a modern electric motor alone. In operating in a hybrid hydraulic-electric mode versus a straight electric mode the resistance of motion in the electric motor powering the hydraulic drive unit is reduced thereby reducing the amount of electricity consumed in return the electricity stored onboard will last longer increasing the range of the vehicle.

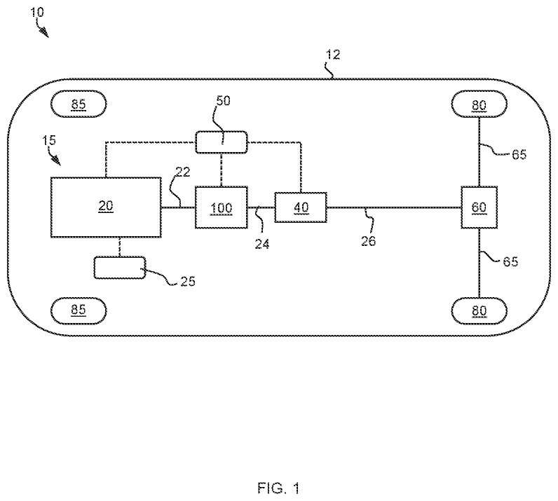

Referring now to FIG. 1, an embodiment of an automobile or motor vehicle 10 is shown. Motor vehicle 10 generally includes a body or chassis 12, a drivetrain 15, an onboard power source 25, and an onboard control system 50. Drivetrain 15, power source 25, and control system 50 are coupled to and physically supported by the chassis 12. Drivetrain 15 of motor vehicle 10 is configured to propel the motor vehicle 10 across the ground or other surface terrain. Power source 25 of motor vehicle 10 may provide fuel, electrical energy, and/or other sources of energy for powering the drivetrain 15. The control system 50 of motor vehicle 10 may control the operation of drivetrain 15. It may be understood that motor vehicle 10 is shown only schematically in FIG. 1 and thus may include features not shown in FIG. 1 such as, for example, a suspension system, a passenger compartment, a storage compartment, etc.

In this exemplary embodiment, drivetrain 15 of motor vehicle 10 generally includes a power unit or prime mover 20, a hydraulic drive unit 100, a transmission 40, a differential 60, and a plurality of driven traction elements 80. Prime mover 20 of drivetrain 15 is connected to the power source 25 and converts energy stored in the power source 25 into rotational torque which is provided to a first or power shaft 22 mechanically connected to the prime mover 20. In this exemplary embodiment, prime mover 20 comprises an electric motor and power source 25 comprises a battery pack which stores electrical energy that is supplied to prime mover 20 to be converted into rotational torque by the prime mover 20. However, in other embodiments, the configuration of prime mover 20 and power source 25 may vary. For example, in other embodiments, prime mover 20 may comprise an ICE and power source 25 may comprise a fuel tank storing fuel (e.g., gasoline, ethanol, natural gas, etc.) that is combusted by the ICE to generate rotational torque in the power shaft 22.

The hydraulic drive unit 100 of powertrain 15, which will be described further herein, is mechanically connected between the prime mover 20 and transmission 40. Particularly, in this exemplary embodiment, hydraulic drive unit 100 is connected to the prime mover 20 by power shaft 22 extending between the prime mover 20 and hydraulic drive unit 100. In this configuration, hydraulic drive unit 100 receives rotational torque from the prime mover 20 via the power shaft 22 connected therebetween. Additionally, hydraulic drive unit 100 is mechanically connected to the transmission 40 by a second or output shaft 24 extending between the hydraulic drive unit 100 and transmission 40. Output shaft 24 receives rotational torque from the hydraulic drive unit 100 and provides the rotational torque outputted by hydraulic drive unit 100 to the transmission 40. As will be discussed further herein, the rotational speed and/or torque of output shaft 24 may vary from the rotational torque and/or speed of power shaft 22.

Transmission 40 of powertrain 15 provides a desired gear reduction to the driven traction elements 80 of powertrain 15. Particularly, transmission 40 is mechanically connected to a third or driveshaft 26 extending from the transmission 40. Transmission 40 provides a desired change between the rotational speed and/or torque of output shaft 24 and the rotational speed and/or torque of driveshaft 26. For example, the transmission 40 may provide a desired rotational speed in the driveshaft 26 that is less than the rotational speed of output shaft 24.

In this exemplary embodiment, transmission 40 comprises a CVT which selectably provides a virtually unlimited number of gear reductions or ratios across the transmission 40. For example, transmission 40 comprises a belt connected between a pair of variable-diameter pulleys. The diameter of one or both of the pulleys of transmission 40 may be adjusted to provide a desired gear reduction across the transmission 40. It may however be understood that the configuration of transmission 40 may vary in other embodiments. For example, in some embodiments, transmission 40 may comprise a gearbox configured to provide a predefined number of fixed gear ratios across the transmission which may be selected by the operator of motor vehicle 10 and/or by the control system 50 to provide a desired rotational speed in the driveshaft 26. In still other embodiments, transmission 40 comprises a hydraulic transmission sometimes referred to as a “hydrostatic transmission” that includes a hydraulic motor configured to provide a desired gear reduction across the transmission 40.

In this exemplary embodiment, rotational torque from driveshaft 26 is delivered to the driven traction elements 80 of drivetrain 15 by a differential 60 and a pair of driven axles 65 connected to the differential 60. The differential 60, connected to the driveshaft 26, receives the rotational torque from driveshaft 26 and divides the received rotational torque between the pair of driven axles 65 also connected to differential 60. Differential 60 may also provide an additional gear reduction to the pair of driven axles 65. Driven traction elements 80, connected to driven axles 65, receive the rotational torque from axles 65 and apply as traction the received rotational torque to the surface terrain along which motor vehicle 10 travels to propel the motor vehicle 10 along the surface terrain.

In this exemplary embodiment, motor vehicle 10 includes an additional pair of traction elements 85 which are not driven by drivetrain 15 forming a real wheel drive (RWD) arrangement. It may be understood that the configuration of drivetrain 15 may vary in other embodiments. As one example, in some embodiments, drivetrain 15 may power each traction element 80, 85 of motor vehicle 10. In other embodiments, drivetrain 15 may not include differential 60 and instead transmission 40 may directly drive the driven traction elements 80. Additionally, while motor vehicle 10 is shown as including four traction elements 80, 85 in FIG. 1, it may be understood that the number of traction elements 80 and/or 85 may vary.

In this exemplary embodiment, traction elements 80, 85 comprise rotatable wheels. For example, traction elements 80, 85 of motor vehicle 10 may each include tires for transferring force to the surface terrain as traction. In other embodiments, traction elements 80, 85 may be coupled to tracks and/or other mechanisms for providing traction to the motor vehicle 10. In still other embodiments, traction elements 80, 85 may comprise mechanisms other than wheels for reacting rotational torque against a surface terrain.

The control system 50 of motor vehicle 10 is generally configured to monitor and/or control various pieces of equipment of motor vehicle 10 including, for example, the prime mover 20, hydraulic drive unit 100, and transmission 40. In this exemplary embodiment, the control system 50 operates the prime mover 20, hydraulic drive unit 100, and/or transmission 40 in response to control inputs by an operator (e.g., an onboard or offboard driver) of motor vehicle 10. However, in other embodiments, at least some components of motor vehicle 10 may be operated autonomously by control system 50. As an example, the control system 50, for example, may provide a desired rotational speed and/or torque in power shaft 22 in response to a control input provided by the operator of motor vehicle 10. As another example, control system 50 may also provide a desired gear reduction across transmission 40 in response to a control input provided by the operator of motor vehicle 10.

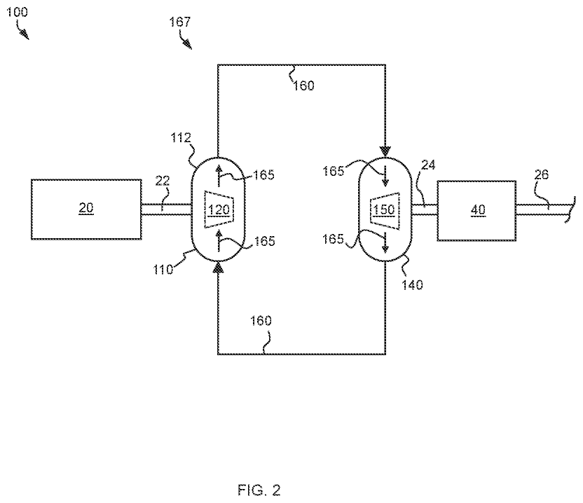

Referring now to FIG. 2, the hydraulic drive unit 100 of the motor vehicle 10 of FIG. 1 is shown. As described above, hydraulic drive unit 100 transfers rotational torque from the power shaft 22 connected to prime mover 20 to the output shaft 24 connected to transmission 24. Hydraulic drive unit 100 may vary the rotational torque and/or speed of output shaft 24 relative to that received by hydraulic drive unit 100 from power shaft 22. Particularly, hydraulic drive unit 100 is configured to extend or maximize an operational range of the motor vehicle 10. To state in other words, by connecting hydraulic drive unit 100 between prime mover 20 and transmission 40, the range of motor vehicle 10 may be increased relative to a configuration of motor vehicle 10 in which prime mover 20 is directly connected to transmission 40 without the inclusion of hydraulic drive unit 100. Thus, by including hydraulic drive unit 100, the range in terms of distance travelable by motor vehicle 10 for a given amount of electrical energy or fuel stored in power source 25 may be maximized. By reducing the resistance of motion with a hydraulic system less electricity is consumed therefore increasing the range of the vehicle.

In this exemplary embodiment, hydraulic drive unit 100 generally includes a hydraulic pump 110 and a hydraulic motor 140. It may be understood that hydraulic drive unit 100 is shown schematically in FIG. 2 and may include features and components not shown in FIG. 2. Hydraulic pump 110 is fluidically connected to the hydraulic motor 140 via a plurality of fluid or hydraulic conduits 160 of hydraulic drive unit 100 which are connected therebetween. Hydraulic pump 110 generally includes a pump housing 112 and a motive element 120 positioned in the pump housing 112. Motive element 120 is configured to circulate hydraulic fluid (indicated by arrows 165 in FIG. 2) through a hydraulic circuit 167 formed by the hydraulic pump 110, hydraulic motor 140, and hydraulic conduits 160. Resistance to fluid flow may be minimized along the hydraulic circuit 167 to maximize the range of the motor vehicle 10 shown in FIG. 1.

In this exemplary embodiment, motive element 120 comprises an impeller which is connected to the power shaft 22 and thus may also be referred to herein as impeller 120. In this configuration, motive element 120 rotates within pump housing 112 to circulate hydraulic fluid 165 along hydraulic circuit 167 in response to the rotation of power shaft 22 by prime mover 20. While in this exemplary embodiment the motive element 120 of hydraulic pump 110 comprises a rotatable impeller 120, it may be understood that in other embodiments the configuration of hydraulic pump 110 may vary. For example, in other embodiments, motive element 120 may comprise one or more gears, screws, reciprocating pistons, and/or other elements configured to circulate the hydraulic fluid 165 along the hydraulic circuit 167.

The Hydraulic motor 140 of hydraulic drive unit 100 generally includes a motor housing 142 and a drive element 150 positioned in the motor housing 142 and connected to the output shaft 24. Drive element 150 is configured to convert fluid pressure of the hydraulic fluid 165 into rotational motion and torque which is transferred to the output shaft 24 connected thereto. In this configuration, circulation of the hydraulic fluid 165 along hydraulic circuit 167 by the operation of hydraulic pump 110 causes drive element 150 to apply rotational torque to the output shaft 24 of motor vehicle 10, where the amount of rotational torque and/or degree of rotational speed applied to output shaft 24 is dependent upon the rate of circulation and/or fluid pressure provided to hydraulic fluid 165 by hydraulic pump 110.

In this exemplary embodiment, similar to hydraulic pump 110, drive element 150 of hydraulic motor 140 comprises an impeller which is connected to the output shaft 24 and thus may also be referred to herein as impeller 150. In this configuration, the rotational torque and/or speed of drive shaft 24 is dependent on the rotational torque applied to impeller 150 by the hydraulic fluid 165. While in this exemplary embodiment the drive element 150 of hydraulic motor 140 comprises a rotatable impeller 150, it may be understood that in other embodiments the configuration of hydraulic motor 140 may vary. For example, in other embodiments, drive element 150 may comprise one or more gears, screws, reciprocating pistons, and/or other elements configured to apply a rotational torque to drive shaft 24 in response to the circulation of hydraulic fluid 165 along hydraulic circuit 167 via the operation of hydraulic pump 110.

As described above, rotational torque generated by the prime mover 20 is applied to the hydraulic pump 110 of hydraulic drive unit 100 which is mechanically connected to prime mover 20 through power shaft 22. The energy applied to hydraulic pump 110 from prime mover 20 is transferred hydraulically to the hydraulic motor 140 of hydraulic drive unit 100 fluidically connected to the hydraulic pump 110. The energy transferred to hydraulic motor 140 may then be transferred to the driven wheels 80 of motor vehicle 10 via the output shaft 24, transmission 40, driveshaft 26, differential 60, and driven axles 65 each mechanically connected to both the driven wheels 80 and the hydraulic motor 140. The energy received by driven wheels 80 may be applied to the surface terrain as traction to propel the motor vehicle 10 across the surface terrain.

While exemplary embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

What is claimed is:

1. A drivetrain for a motor vehicle, comprising:
a prime mover comprising a rotatable power shaft, wherein the prime mover is configured to translate energy stored in a power source into rotational torque that is applied to the power shaft;
a hydraulic drive unit comprising a hydraulic pump mechanically connected to the power shaft, a hydraulic motor fluidically connected to the hydraulic pump, and an output shaft mechanically connected to the hydraulic motor; and
a transmission mechanically connected to the output shaft and configured to provide one or more gear reductions across the transmission.

2. The drivetrain of claim 1, wherein the hydraulic pump comprises a pump housing and a motive element positioned in the pump housing and mechanically connected to the power shaft.

3. The drivetrain of claim 2, wherein the motive element of the hydraulic pump comprises at least one of an impeller rotatably positioned in the pump housing and a piston reciprocally positioned in the pump housing.

4. The drivetrain of claim 1, wherein the hydraulic motor comprises a motor housing and a drive element positioned in the motor housing and mechanically connected to the output shaft.

5. The drivetrain of claim 4, wherein the drive element of the hydraulic pump comprises at least one of an impeller rotatably positioned in the motor housing and a piston reciprocally positioned in the motor housing.

6. The drivetrain of claim 1, wherein the prime mover comprises an electric motor configured to output rotational torque to the power shaft in response to being provided with electrical energy from the power source.

7. The drivetrain of claim 1, wherein the transmission comprises a continuously variable transmission (CVT).

8. A motor vehicle, comprising;
a chassis;
a power source supported on the chassis;
a prime mover supported on the chassis and comprising a rotatable power shaft, wherein the prime mover is configured to translate energy stored in the power source into rotational torque that is applied to the power shaft;
a hydraulic drive unit supported on the chassis and mechanically connected to the power shaft, wherein the hydraulic drive unit comprises a hydraulic circuit and an output shaft connected to the power shaft through the hydraulic circuit;
a transmission mechanically connected to the output shaft of the hydraulic drive unit and configured to provide one or more gear reductions across the transmission; and
one or more traction elements mechanically connected to the transmission and configured to react a force against a surface terrain in response to the operation of the prime mover.

9. The motor vehicle of claim 8, further comprising a control system supported on the chassis and in signal communication with the prime mover, hydraulic drive unit, and transmission.

10. The motor vehicle of claim 8, wherein the one or more traction elements comprise one or more wheels rotatably coupled to the transmission.

11. The motor vehicle of claim 10, further comprising a differential mechanically connected between the transmission and the one or more wheels.

12. The motor vehicle of claim 8, wherein the hydraulic drive unit comprises a hydraulic pump mechanically connected to the power shaft, and a hydraulic motor fluidically connected to the hydraulic pump and mechanically connected to the output shaft.

13. The motor vehicle of claim 12, wherein the hydraulic pump comprises a pump housing and a motive element positioned in the pump housing and mechanically connected to the power shaft.

14. The motor vehicle of claim 13, wherein the motive element of the hydraulic pump comprises at least one of an impeller rotatably positioned in the pump housing and a piston reciprocally positioned in the pump housing.

15. The motor vehicle of claim 12, wherein the hydraulic motor comprises a motor housing and a drive element positioned in the motor housing and mechanically connected to the output shaft.

16. The motor vehicle of claim 15, wherein the drive element of the hydraulic pump comprises at least one of an impeller rotatably positioned in the motor housing and a piston reciprocally positioned in the motor housing.

17. The motor vehicle of claim 8, wherein the prime mover comprises an electric motor configured to output rotational torque to the power shaft in response to being provided with electrical energy from the power source.

18. The motor vehicle of claim 8, wherein the transmission comprises a continuously variable transmission (CVT).
